(19) United States
(12) Patent Application Publication
(10) Pub. No.: US 2014/0078540 A1
(43) Pub. Date: Mar. 20, 2014

(54) PRINTING SYSTEM, PRINT INSTRUCTION APPARATUS AND NON-TRANSITORY COMPUTER-READABLE STORAGE MEDIUM

(71) Applicant: KONICA MINOLTA, INC., Chiyoda-ku (JP)

(72) Inventor: Tetsuya Ishida, Inagi-shi (JP)

(73) Assignee: KONICA MINOLTA, INC., Chiyoda-ku (JP)

(21) Appl. No.: 14/029,022

(22) Filed: Sep. 17, 2013

(30) Foreign Application Priority Data
Sep. 20, 2012 (JP) 2012-206450

(51) Int. Cl. H04N 1/00

(52) U.S. Cl. CPC H04N 1/00896
USPC 358/1.13

(57) ABSTRACT

A printing system includes plural image forming apparatuses and a print instruction apparatus connected through a communication network. The control section of the print instruction apparatus includes a database holding an apparatus information list and an apparatus managing section configured to transmit live confirming information to each of the image forming apparatuses with referring to the apparatus information list, recognize image forming apparatuses connected to the communication network based on receipt of response to the live confirming information, transmit an acquisition request of device information to an image forming apparatus selected on a screen showing a list of the recognized image forming apparatuses, and acquire the apparatus information from the selected image forming apparatus. Each image forming apparatus is configured to respond to the live confirming information without returning to a normal-power state from a power-saving state, and generate the acquired apparatus information with returning to the normal-power state.

This application is based on Japanese Patent Application No. 2012-206450 filed on Sep. 20, 2012, in the Japan Patent Office, the entire content of which is hereby incorporated by reference.

### TECHNICAL FIELD

The present invention relates to a printing system, a print instruction apparatus and a non-transitory computer-readable storage medium storing printer driver software, and specifically relates to a printing system, a print instruction apparatus and a non-transitory computer-readable storage medium storing printer driver software, each of which maintains a sleep state of an image forming apparatus to improve the power saving capability thereof.

### BACKGROUND

An image forming apparatus, such as a printer, an MFP (Multi-Functional Peripherals), and the like, performs various kinds of controlling operations, including an operation to keep a temperature of a fixing device that fixes a toner image formed on a paper sheet thereon, in order to shorten a waiting time until a print product is outputted therefrom. Such the image forming apparatus consumes a relatively large amount of electric power in a ready state (normal-power state) thereof. In view of this matter, under the condition that an unused state of the image forming apparatus lasts for a long time, the operating state of the image forming apparatus is made to shift from the ready state to the sleep state (power-saving state) in which an amount of electric power to be consumed is smaller than that in the ready state, so as to reduce the electric power consumption.

In addition to the above, image forming apparatuses each having the following structure are coming into wide use in order to further reduce the electric power consumption at the time of the sleep state: each of the image forming apparatus is provided with both a main CPU (Central Processing Unit) and a sub CPU, so that only the main CPU is made to sleep in the sleep state, while the sub CPU monitors recovery conditions even in the sleep state. As examples of functions to achieve the structure, there are known various kinds of functions, including a filtering function for selecting only packets for which a recovering processing is necessary at the time when receiving a network packet and abandoning other packets, a function for waking up (resuming) the main CPU when receiving the packet that is in conformity with the filtering condition, a proxy responding function for making only the sub CPU respond when receiving the packet that is in conformity with the filtering condition.

With respect to the proxy responding function above-mentioned, for instance, Japanese Patent Application Laid-Open Publication (JP-A) No. 2010-125692 discloses the following image forming apparatus. The image forming apparatus is provided with: a receiving section to receive image data sent from a host apparatus through a network; an image forming section to form an image based on the image data received by the receiving section; and a controlling section to control image forming operations to be performed by the image forming section. In a case of a first power-ON state in which an electric power is supplied to both the image forming section and the controlling section, and in another case of a second power-ON state in which the electric power is supplied to the controlling section but is cut off to the image forming section, in response to a receipt of an inquiry in regard to apparatus information of own apparatus from the host apparatus, the controlling section transmits the apparatus information of the own apparatus, which is stored in a first storage section included in the controlling section, to the host apparatus concerned, or the controlling section detects the apparatus information of the own apparatus to transmit the detected apparatus information to the host apparatus concerned. In a case of a third power-ON state in which the electric power is cut off to both the image forming section and the controlling section, in response to a receipt of the inquiry in regard to the apparatus information of the own apparatus from the host apparatus, the receiving section transmits the apparatus information of the own apparatus, which is stored in a second storage section, which is referable even in the third power-ON state, to the host apparatus concerned, or the receiving section transmits a notification that it is impossible for the receiving section to transmit the apparatus information of the own apparatus. This image forming apparatus employs an exclusive hardware so as to maintain the sleep state of the image forming apparatus by creating and transmitting the responding packet without resuming the main CPU.

However, in many cases, since some restrictions are incurred for realizing the proxy responding function, above-mentioned, from a resource or a cost point of view. Further, depending on the properties of the proxy responding function or the network environment, the image forming apparatus can receive a greater number of packets more than expected, even if the packets to be received are limited to those necessary to be processed. As a result, the image forming apparatus is hardly maintained in the sleep state, and instead, frequently returns into the ready state, which hardly reduces the electric power consumption of the image forming apparatus concerned effectively.

Further, in a case where plural kinds of image forming apparatuses are connected to each other through the network, it should be necessary to install various kinds of printer driver software, respectively corresponding to the plural kinds of image forming apparatuses, into each of client computer-terminal devices, which makes the user's operations complicated. To solve this problem, in recent years, common printer driver software (referred as UPD (Universal Printer Driver)) which commonly handles the plural kinds of image forming apparatuses, has been brought into practice. The UPD software casts a broadcast packet for retrieving one of the image forming apparatuses into the network system. Then, receiving the broadcast packet, each of the image forming apparatuses reenters into the ready state to supply apparatus information to the packet. Accordingly, in a case where a lot of computer apparatuses, into which the Universal Printer Driver is installed, are connected to the network, every time when the Universal Printer Driver software is started, the image forming apparatuses reenter into the ready state, which furthermore hardly reduces the electric power consumption of the image forming apparatuses. The present invention seeks to solve the problems.

### SUMMARY

There are disclosed illustrative printing systems, print instruction apparatuses and non-transitory computer-readable storage media each storing printer driver software therein.

An illustrative printing system reflecting one aspect of the present invention is a printing system comprising: a plurality of image forming apparatuses each configured to perform print processing; and a print instruction apparatus connected to the plurality of image forming apparatuses through a communication network and being capable of transmitting a print instruction to each of the plurality of image forming apparatuses. The print instruction apparatus comprises: a control section configured to control operations to transmit the print instruction to each of the plurality of image forming apparatuses. The control section includes a database and an apparatus managing section. The database is configured to hold an apparatus information list, where the apparatus information list includes at least identification information of each of the plurality of image forming apparatuses. The apparatus managing section is configured to transmit live confirming information to confirm a live status to each of the plurality of image forming apparatuses with referring to the apparatus information list, where the live confirming information is information to which each of the plurality of image forming apparatuses under a power-saving state can respond. The power-saving state is a state in which the each of the plurality of image forming apparatuses consumes less power than in a normal-power state. The apparatus managing section is configured to recognize image forming apparatuses connected to the communication network, as recognized image forming apparatuses, out of the plurality of image forming apparatuses, based on whether or not the apparatus managing section receives information responding to the live confirming information. The apparatus managing section is configured to transmit an acquisition request to acquire apparatus information to an image forming apparatus selected on a screen, as a selected image forming apparatus, where the screen shows a list of the recognized image forming apparatuses. The acquisition request is a request to which the each of the plurality of image forming apparatuses under the normal-power state can respond. The apparatus managing section is configured to acquire the apparatus information from the selected image forming apparatus so that the print instruction apparatus can transmit a print instruction to the selected image forming apparatus. The print instruction apparatus further comprises: a display section configured to display the screen showing the list of the recognized image forming apparatuses so as to allow a user to select at least one of the recognized image forming apparatuses. Each of the plurality of image forming apparatuses is configured to transmit, in response to a reception of the live confirming information, the information responding to the live confirming information to the print instruction apparatus without returning to the normal-power state from the power-saving state. Each of the plurality of image forming apparatuses is configured to generate the apparatus information with returning to the normal-power state, in response to a reception of the acquisition request of the apparatus information transmitted to the selected image forming apparatus.

An illustrative print instruction apparatus reflecting another aspect of the present invention is a print instruction apparatus connected to a plurality of image forming apparatuses through a communication network and being capable of transmitting a print instruction to each of the plurality of image forming apparatuses. The print instruction apparatus comprises: a control section configured to control operations to transmit the print instruction to each of the plurality of image forming apparatuses. The control section includes a database and an apparatus managing section. The database is configured to hold an apparatus information list, where the apparatus information list includes at least identification information of each of the plurality of image forming apparatuses. The apparatus managing section is configured to transmit live confirming information to confirm a live status to each of the plurality of image forming apparatuses with referring to the apparatus information list, where the live confirming information is information to which each of the plurality of image forming apparatuses under a power-saving state can respond. The power-saving state is a state in which the each of the plurality of image forming apparatuses consumes less power than in a normal-power state. The apparatus managing section is configured to recognize image forming apparatuses connected to the communication network, as recognized image forming apparatuses, out of the plurality of image forming apparatuses, based on whether or not the apparatus managing section receives information responding to the live confirming information. The apparatus managing section is configured to transmit an acquisition request to acquire apparatus information to an image forming apparatus selected on a screen, as a selected image forming apparatus, where the screen shows a list of the recognized image forming apparatuses. The acquisition request is a request to which the each of the plurality of image forming apparatuses under the normal-power state can respond. The apparatus managing section is configured to acquire the apparatus information from the selected image forming apparatus so that the print instruction apparatus can transmit a print instruction to the selected image forming apparatus. The print instruction apparatus further comprises: a display section configured to display the screen showing the list of the recognized image forming apparatuses so as to allow a user to select at least one of the recognized image forming apparatuses.

An illustrative non-transitory computer-readable storage medium reflecting another aspect of the present invention is a non-transitory computer-readable storage medium storing printer driver software, serving as a computer executable program to be executed in a print instruction apparatus connected to a plurality of image forming apparatuses through a communication network. The print instruction apparatus is capable of transmitting a print instruction to each of the plurality of image forming apparatuses. The print instruction apparatus includes a database holding an apparatus information list, where the apparatus information list includes at least identification information of each of the plurality of image forming apparatuses. The program is executable by a computer to cause the computer to perform a process comprising: transmitting live confirming information to confirm a live status to each of the plurality of image forming apparatuses with referring to the apparatus information list, where the live confirming information is information to which each of the plurality of image forming apparatuses under a power-saving state can respond. The power-saving state is a state in which the each of the plurality of image forming apparatuses consumes less power than in a normal-power state. The process further comprises recognizing image forming apparatuses connected to the communication network, as recognized image forming apparatuses, out of the plurality of image forming apparatuses, based on a receipt of information responding to the live confirming information, and transmitting an acquisition request to acquire apparatus information to an image forming apparatus selected on a screen, as a selected image forming apparatus, where the screen shows a list of the recognized image forming apparatuses. The acquisition request is a request to which the each of the plurality of image forming apparatuses under the normal-power state can respond. The process further comprises acquiring the apparatus information from the selected image forming apparatus so that the print instruction apparatus can transmit a print instruction to the selected image forming apparatus; and transmitting a print instruction to the selected image forming apparatus.

Other features of illustrative embodiments will be described below.

### BRIEF DESCRIPTION OF THE DRAWINGS

Embodiments will now be described, by way of example only, with reference to the accompanying drawings which are meant to be exemplary, not limiting, and wherein like elements numbered alike in several figures, in which:

FIG. 1 is a schematic diagram showing a configuration of a printing system in accordance with an embodiment of the present invention;

FIG. 2 is a block diagram showing a configuration of a client apparatus in accordance with an embodiment of the present invention;

FIG. 3 is a block diagram showing a configuration of an image forming apparatus in accordance with an embodiment of the present invention;

FIG. 4 is a block diagram showing a configuration of Universal Printer Driver software in accordance with the embodiment of the present invention;

FIG. 5 is a table showing an example of an apparatus information list to be kept by the Universal Printer Driver software in accordance with the embodiment of the present invention;

FIG. 6 is a flowchart illustrating startup processing to be conducted by the Universal Printer Driver software in accordance with the embodiment of the present invention;

FIG. 7 is a flowchart illustrating a live confirmation processing in the startup processing to be conducted by the Universal Printer Driver software in accordance with the embodiment of the present invention;

FIG. 8 is a schematic diagram showing an example of an apparatus selecting screen to be displayed by the Universal Printer Driver software in accordance with the embodiment of the present invention;

FIG. 9 is a flowchart illustrating print instruction processing to be conducted by the Universal Printer Driver software in accordance with the embodiment of the present invention.

FIG. 10 is a schematic diagrams showing an example of an apparatus selecting screen (in a state that an apparatus is selected) to be displayed by the Universal Printer Driver software in accordance with the embodiment of the present invention;

FIG. 11 is a schematic diagrams showing an example of an apparatus selecting screen (in a state that a function is selected) to be displayed by the Universal Printer Driver software in accordance with the embodiment of the present invention; and

FIG. 12 is a flowchart illustrating a processing for confirming a apparatus information list, to be conducted by the Universal Printer Driver software in accordance with the embodiment of the present invention.

### DETAILED DESCRIPTION

Illustrative embodiments of printing systems, print instruction apparatuses and non-transitory computer-readable storage media each storing printer driver software will be described with reference to the drawings. It will be appreciated by those of ordinary skill in the art that the description given herein with respect to those figures is for exemplary purposes only and is not intended in any way to limit the scope of potential embodiments may be resolved by referring to the appended claims.

Printing systems, print instruction apparatuses and non-transitory computer-readable storage media each storing printer driver software as embodiments of the present invention, allow the following matters in such an environment where a plurality of image forming apparatuses and a print instruction apparatus which is capable of issuing print instructions to the plurality of image forming apparatuses, are coupled to each other through the communication network. It is possible to suppress a number of unnecessary recovery actions from the sleep state to the ready state in the image forming apparatuses, and as a result, it becomes possible to effectively reduce the electric power consumption of the image forming apparatuses.

This is because, the print instruction apparatus (printer driver software) performs the following processing. The print instruction apparatus (printer driver software) keeps an apparatus information list in which at least identification information of each of the image forming apparatuses is described, and individually transmits live confirming information to which each of the image forming apparatuses under a sleep state is responsive, to each of the image forming apparatuses, with referring to the apparatus information list. Further, the print instruction apparatus (printer driver software), based on the results of whether or not response information to the live confirming information has been received, recognizes the image forming apparatuses currently living (namely, currently being connected to the network), and transmits an acquisition request of the apparatus information to which each of the image forming apparatuses under a ready is responsive, to the image forming apparatus selected from the image forming apparatuses recognized as currently living.

As illustrated in the description about the background, in order to achieve the power saving capability of the image forming apparatus, it is important to control the image forming apparatus not to unnecessarily reenter into the ready state (normal-power state) from the sleep state (power-saving state). For this purpose, proposed is the proxy responding function that employs the exclusive hardware to create and transmit the response packet without resuming the main CPU, so as to maintain the sleep state of the image forming apparatus.

However, since some restrictions are incurred for realizing the proxy responding function from a resource or a cost-effectiveness point of view. Further, depending on the properties of the proxy responding function or the network environment, the image forming apparatus reenters into the ready state by every one of the many packets received, which hardly maintains the image forming apparatus in the sleep state. Specifically, in a network environment where the UPD software is employed, since the UPD software casts a broadcast packet for retrieving one of the image forming apparatuses into the network system, each of the image forming apparatuses which have received the broadcast packet, frequently reenters into the ready state. Therefore, it has been difficult to reduce the electric power consumption effectively.

In view of the above-mentioned matters, there is provided a print instruction apparatus (printer driver software) as an embodiment of the present invention. The print instruction apparatus is capable of transmitting a print instruction to the plurality of image forming apparatuses, and holds an apparatus information list including at least identification information of the image forming apparatuses. Further, the print instruction apparatus is configured to perform the following processing. The print instruction apparatus individually transmits live confirming information to each of the plurality of image forming apparatuses with referring to the apparatus information list, instead of casting a broadcast packet to retrieving a specified image forming apparatus into the network. Herein, the live confirming information is information to which each of the image forming apparatuses currently under the sleep state is responsive as it is (for instance, a “Ping packet”). By confirming the response to the live confirming information coming from each of the image forming apparatuses, the print instruction apparatus recognizes the image forming apparatuses currently living (namely, currently being coupled to the network), to notify the recognized image forming apparatuses to a user, for example by using a screen showing the recognized image forming apparatuses currently living. Successively, the print instruction apparatus transmits an apparatus-information acquisition request, to which each of the image forming apparatuses under the ready state is responsive, to an image forming apparatus selected from the recognized image forming apparatuses currently living. Then, the print instruction apparatus acquire the apparatus information from the selected image forming apparatus so that the print instruction apparatus can transmit a print instruction to the selected image forming apparatus.

### EXAMPLES

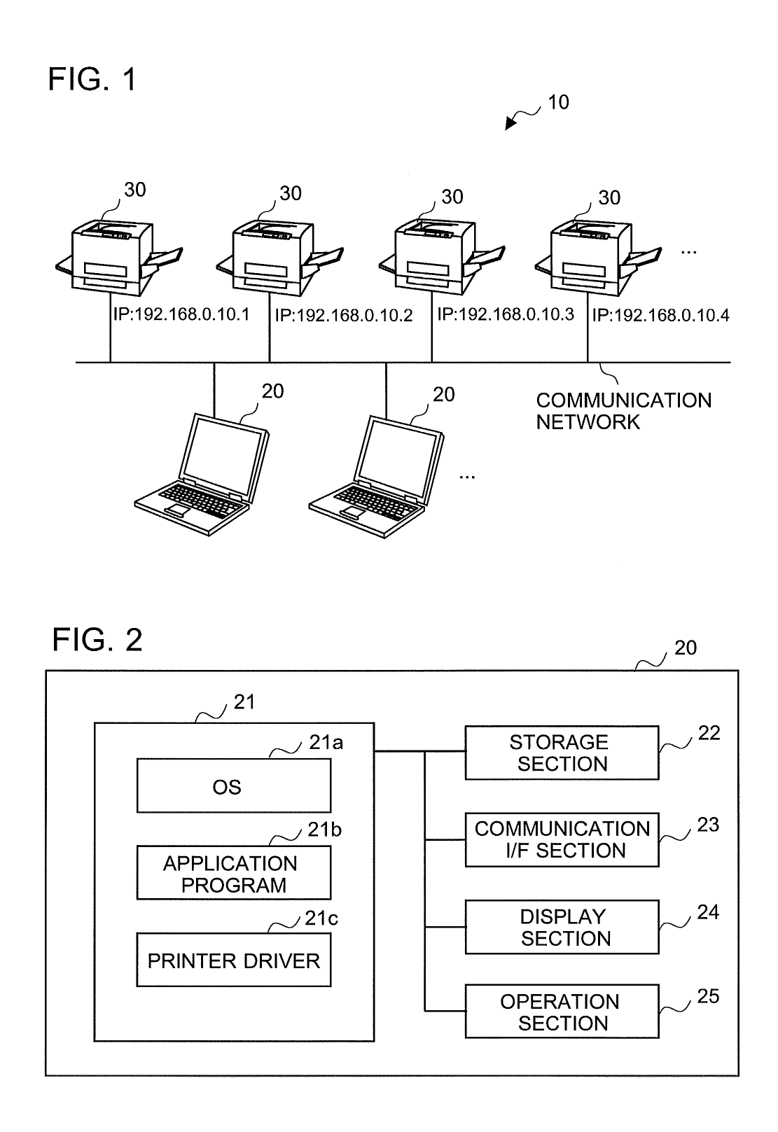

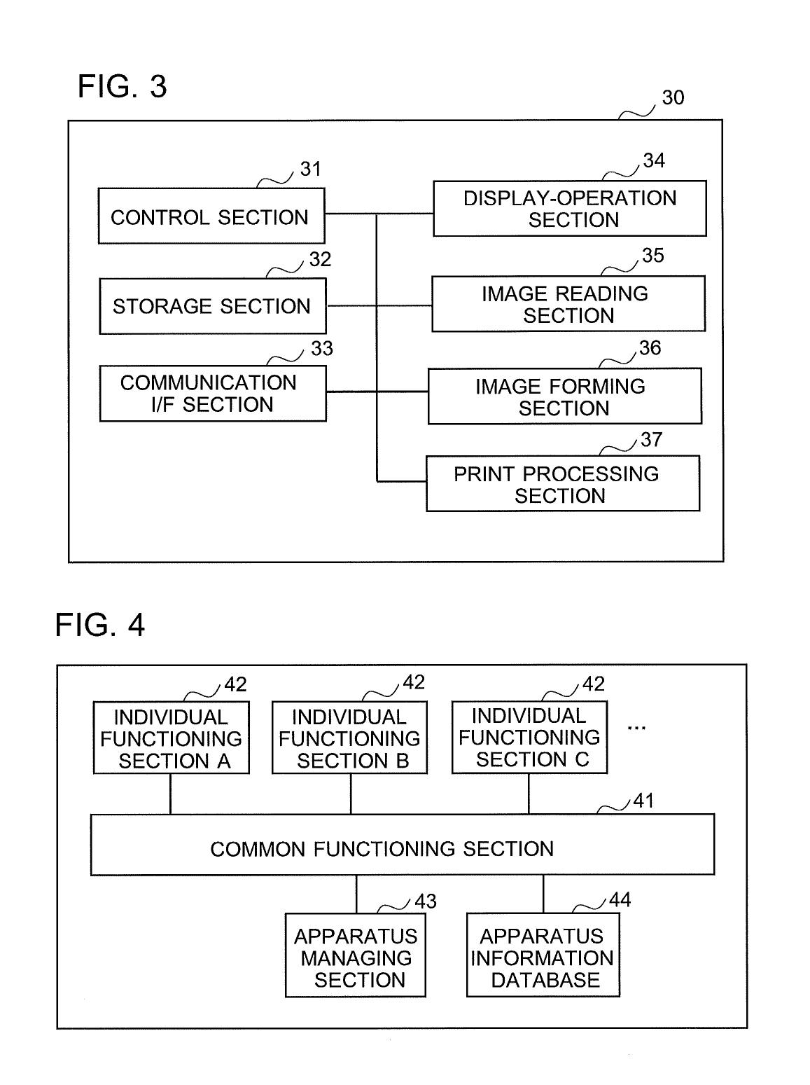

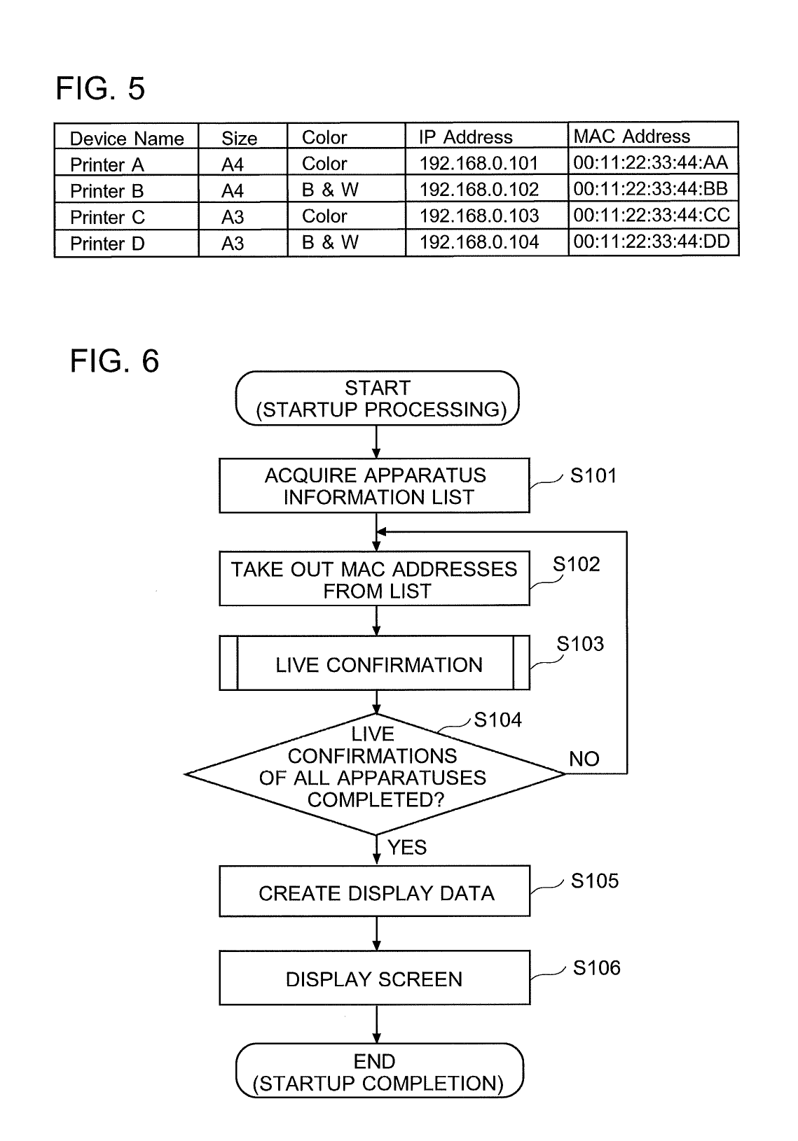

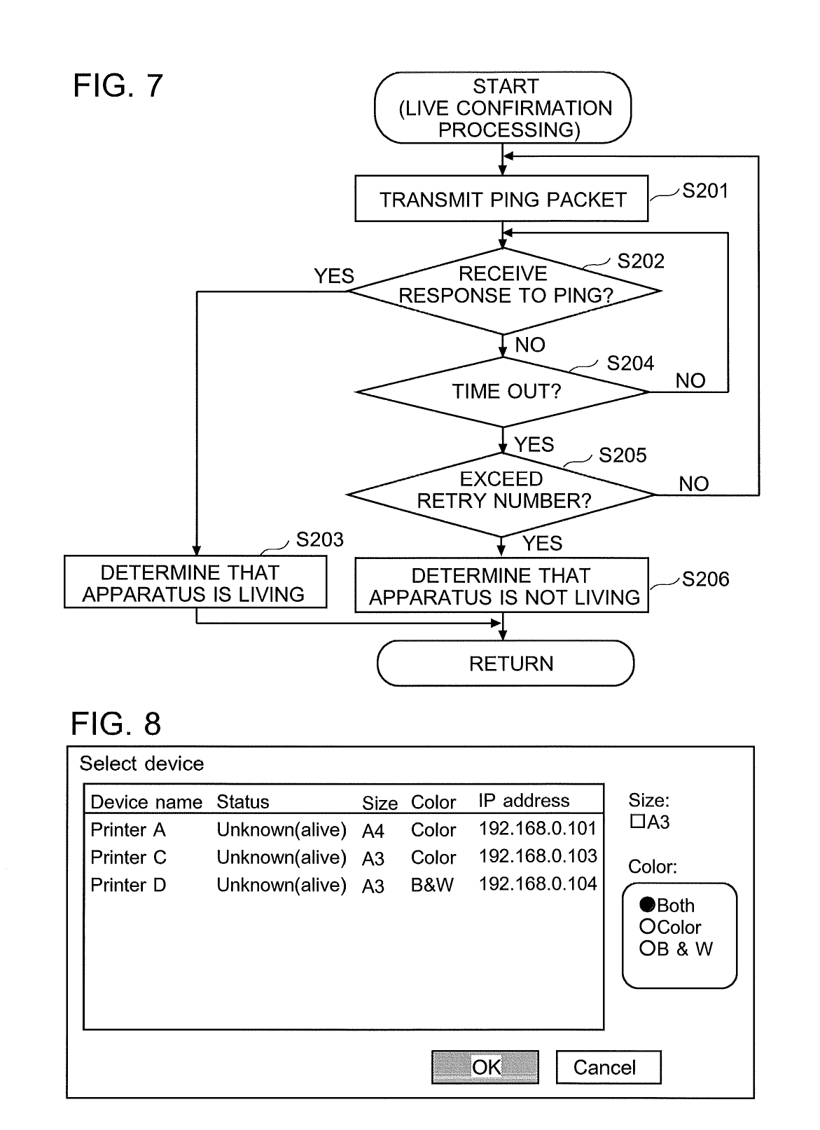

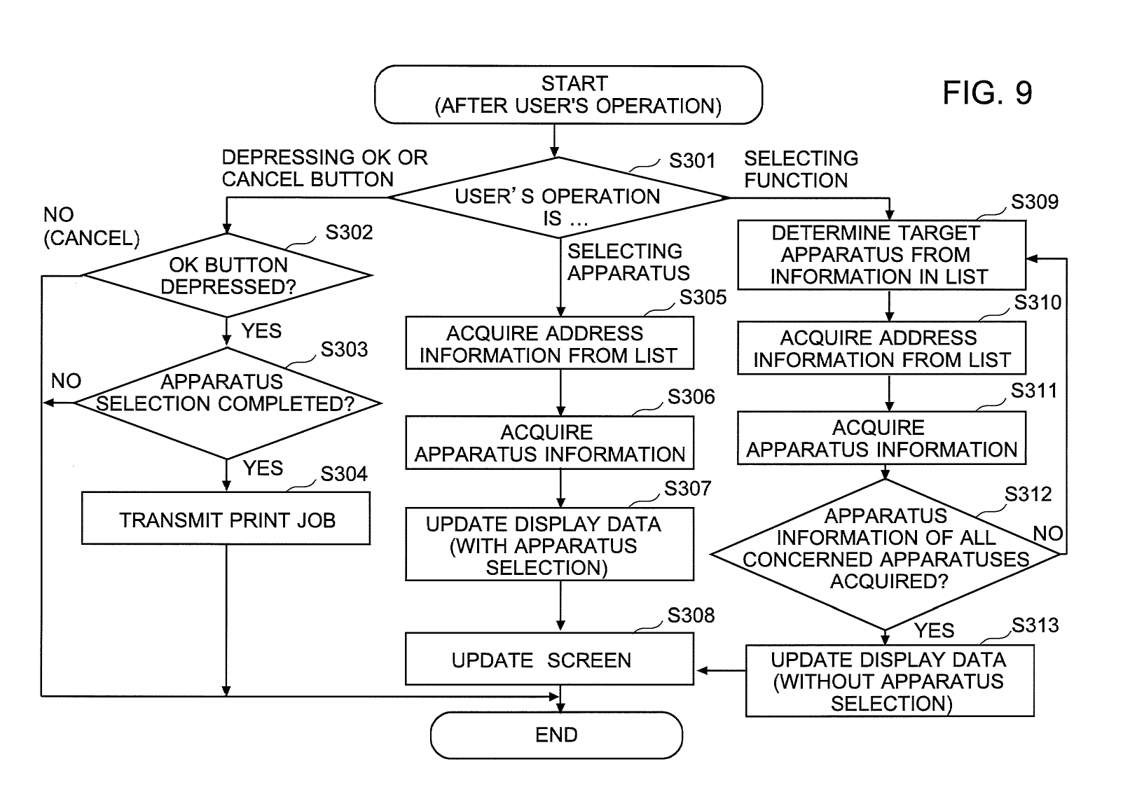

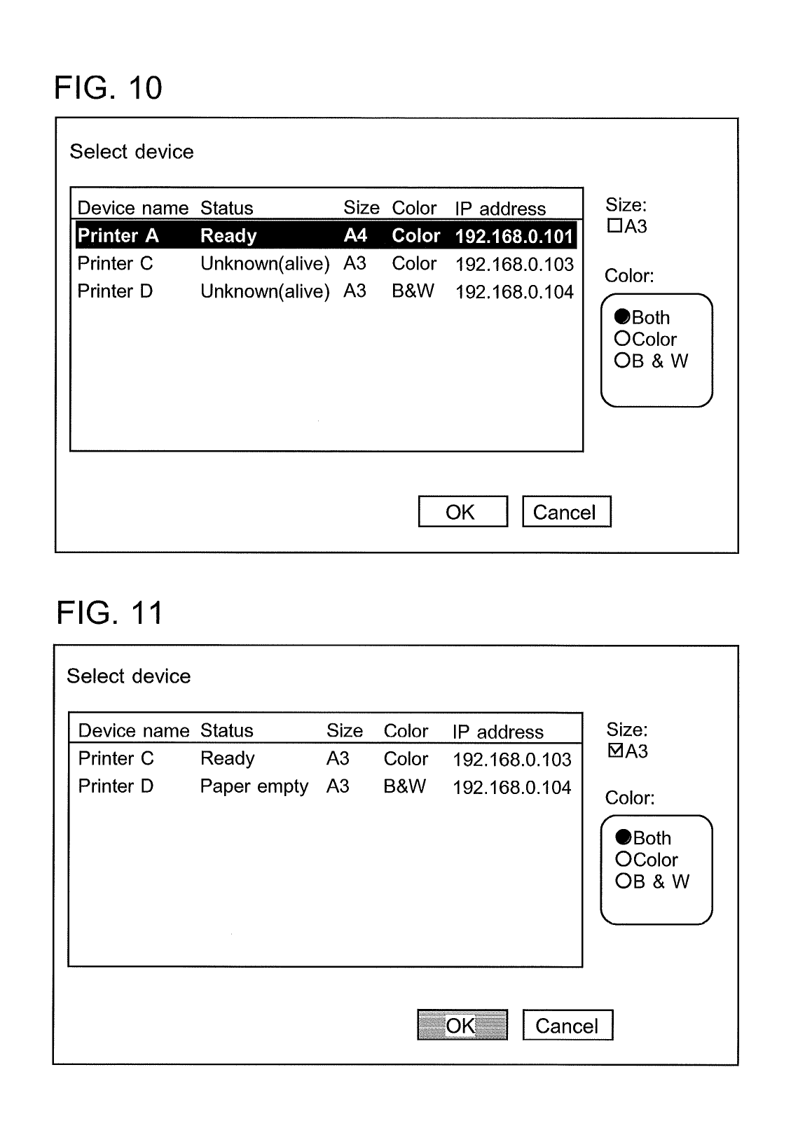

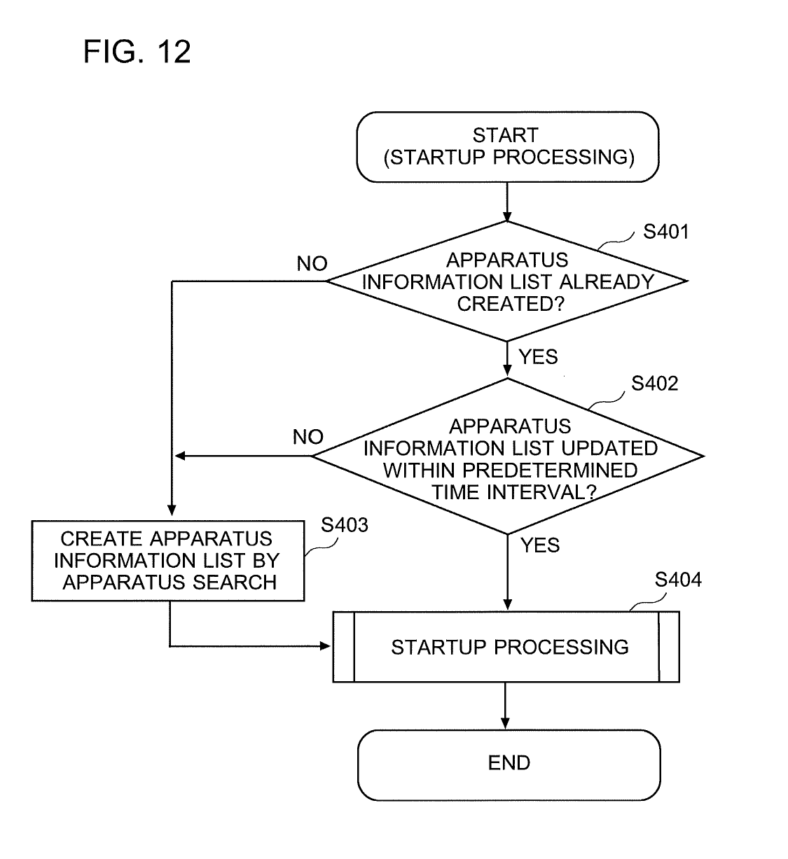

In order to further describe the preferred embodiment of the present invention in detail, referring to FIG. 1 through FIG. 12, a printing system, a print instruction apparatus and a printer driver, as an example of the present invention, will be detailed in the following. FIG. 1 is a schematic diagram showing a configuration of the printing system of the present example, FIG. 2 is a block diagram showing a configuration of the client apparatus of the present example, and FIG. 3 is a block diagram showing a configuration of the image forming apparatus of the present example. Further, FIG. 4 is a block diagram showing a configuration of the Universal Printer Driver software of the present example, and FIG. 5 is a table showing an example of the apparatus information list to he kept by the Universal Printer Driver software. Still further, FIG. 6, FIG. 7, FIG. 9 and FIG. 12 are flowcharts illustrating processing to be conducted by the Universal Printer Driver software of the present example, and FIG. 8, FIG. 10 and FIG. 11 are schematic diagrams showing examples of the apparatus selecting screens to be displayed by the Universal Printer Driver software of the present example.

As shown in FIG. 1, a printing system 10 of the present example includes print instruction apparatuses as clients, each of which transmits a print job to instruct a printing operation (hereinafter, each referred to as a client apparatus 20) and a plurality of image forming apparatuses 30, each of which receives the print job to implement the printing operation. The client apparatuses 20 and the image forming apparatuses 30 are connected to each other through a communication network, such as a LAN (Local Area Network), a WAN (Wide Area Network), and the like, each of which is in conformity with any one of the communication standards including an Ethernet (Registered Trademark), a Token Ring, an FDDI (Fiber-Distribution Data Interface), and the line. Each of the apparatuses will be detailed in the following.

### Client Apparatus:

As shown in FIG. 2, the client apparatus 20 includes a control section 21, a storage section 22, a communication interface section 23, a display section 24 and an operation section 25.

The control section 21 is composed of a CPU (Central Processing Unit) and storage devices including a ROM (Read Only Memory), a RAM (Random Access Memory), and the like. The CPU reads out various kinds of programs for controlling the operations to be performed in the client apparatus 20, an OS (Operating System) 21a, application programs 21b, printer driver software 21c (detailed later) as needed from the ROM or the storage section 22, and develops them on the RAM so as to execute the developed programs.

The storage section 22 is composed of a device such as an HDD (Hard Disc Drive), to store data such as various kinds of programs, print jobs, and document data created by executing the application programs 21b, therein.

The communication interface section 23 is composed of a device such as a NIC (Network Interface Card) and a modem, and is configured to perform the following processing. The communication interface section 23 transmit live confirming information (for instance, a Ping packet) for confirming whether or not the image forming apparatus 30 concerned is currently living, to each of the image forming apparatuses 30, according to the instruction issued by the printer driver 21c. Further, according to the instruction issued by the printer driver software 21c, the communication interface section 23 transmits the acquisition request to acquire apparatus information to an image forming apparatus 30 selected from among the image forming apparatuses 30 which are currently living. The expression of “image forming apparatus(es) 30 is/are currently living” is defined as such a state that the image forming apparatus(es) 30 is/are currently connected to the same network to which the client apparatus 20 concerned is also connected, and the communication interface section of the image forming apparatuses 30 is currently capable of responding to the live confirming information above-mentioned (in other words, the condition that at least a power source of the image forming apparatuses 30 is turned ON, for instance, either in the sleep state or the ready state). While, the expression of “image forming apparatus(es) 30 is/are not living” is defined as such another state that the image forming apparatus(es) 30 is/are not connected to the same network to which the client apparatus 20 concerned is also connected, or that the power source(s) of the image forming apparatus(es) 30 is/are turned OFF, though the image forming apparatus(es) 30 is/are currently connected to the same network to which the client apparatus 20 concerned is also connected.

The display section 24 is composed of a device such as an LCD (Liquid Crystal Display), and is configured to display a screen which allows a user to select a specific image forming apparatus 30 from which the apparatus information is to be acquired, and another setting screen from which the printing conditions are settable, thereon.

The operation section 25 is composed of a device such as a mouse and a keyboard, and is configured to allow a user to perform various kinds of operations, such as an operation to create a document by executing one of the application programs 21b and an operation to instruct printing by executing the printer driver software 21c.

In the present example, the printing system 10 employs the client apparatuses 20 as the print instruction apparatus. Alternatively, the printing system 10 may employ a print server connected to the network, to create a printer icon (print queue) for utilizing the printer driver installed in the printer server so as to commonly own the print queue thereof on the network. In that case, the print server can be considered to serve as the print instruction apparatus.

### Image Forming Apparatus:

As shown in FIG. 3, each of the image forming apparatuses 30 includes a control section 31, a storage section 32, a communication interface section 33, a display-operation section 34, an image reading section 35, an image forming section 36 and a print processing section 37. Each of the image forming apparatuses 30 is configured to turn into a ready state (normal-power state) and a sleep state (power-saving state) in which each of the image forming apparatuses 30 consumes a smaller amount of electric power than that in the ready state. Further, IP (Internet Protocol) addresses, such as 192.168.0.101, 192.168.0.102, 192.168.0.103, and so on, are allotted to the image forming apparatuses 30, respectively.

The control section 31 is composed of a CPU (Central Processing Unit) and storage devices including a ROM (Read Only Memory), a RAM (Random Access Memory), and the like. The CPU is configured to perform the following processing. The CPU reads out various kinds of programs from the ROM or the storage section 32 to develop the read-out programs onto the RAM, and executes the programs developed in the RAM. Further, in response to the acquisition request of apparatus information transmitted from the client apparatus 20, the control section 31 makes the apparatus information, which represents the state of the own apparatus, acquirable. In a case where the image forming apparatuses 30 are in conformity with the SNMP (Simple Network Management Protocol), since the apparatus information is kept as the object in the MIB (Management Information Base) having a tree structure, it is possible for the client apparatus 20 to acquire the apparatus information of the image forming apparatus 30 concerned, by employing the SNMP manager command for designating the OID (Object Identifier).

The storage section 32 is composed of a device such as an HDD (Hard Disc Drive), to store data such as various kinds of programs, print jobs, and image data processed by the image forming section 36, therein.

The communication interface section 33 is composed of a device such as a NIC (Network Interface Card) and a modem, and is configured to perform the following processing. The communication interface section 33 receives print data transmitted from the client apparatus 20 through the communication network. Further, receiving the live confirming information (Ping packet) transmitted from the client apparatus 20, the communication interface section 33 issues a response to the live confirming information currently received, without waking up (resuming) the image forming apparatuses 30, in other words, without making the image forming apparatuses 30 return to the ready state from the sleep state.

The display-operation section 34 includes a display unit such as a pressure-sensitive operating unit (touch panel) provided by arranging transparent electrodes in a lattice pattern on a display section of a liquid crystal display device. The display-operation section 34 is configured to display various kinds of screens for operating the image forming apparatuses 30 and setting screens for setting printing conditions and to allow a user to input various kinds of settings and instructions thereon.

The image reading section 35 serves as a section to optically read image data from a document currently place on a document placing plate, and is composed of a light source to emit light to be scanned on the document, an image sensor, such as a CCD (Charge Coupled Device) that converts the light reflected from the document to an electric signal, and the like, and an analogue-to-digital converter to apply analogue-to-digital conversion processing to the electric signal.

The image forming section 36 is configured to perform the following processing. The image forming section 36 parses the print job. Then, the image forming section 36 rasterizes each of pages represented by the print job so as to create image data for every page thereof, or acquires image data for every page from the image reading section 35. The image forming section 36 converts the image data into printable image data in the print processing section, after applying various kinds of image processing (including color adjustment, density adjustment, size adjustment, and the like) and a screening operation on the image data above-acquired.

The print processing section 37 is composed of various kinds of constituents necessary for performing an image forming operation in accordance with a specific image forming process, such as the electro-photographic method and the electrostatic recording method, and is configured to print an image, based on the image data read from the image reading section 35 or the other image data created from the print job received through the communication interface section 33, onto the paper sheet designated.

Next, the printer driver software 21c to be executed in the client apparatus 20 will be detailed in the following. The printer driver software 21c of the present example serves as the Universal Printer Driver software that commonly handles the plural kinds of image forming apparatuses. The printer driver software 21c causes the client apparatus 20 to communicate with the image forming apparatuses 30 through the communication network; detect specific image forming apparatuses 30 that are currently in the outputting ready state; select an image forming apparatus 30 desired by a user from the specific image forming apparatuses 30 above-detected; perform print setting operations according to instructions inputted by the user; perform the outputting operation of the job; and instruct the print implementation. As shown in FIG. 4, the Universal Printer Driver software forms, when being executed in the client apparatus, a common functioning section 41, individual functioning sections 42, an apparatus managing section 43, and an apparatus information database 44.

The common functioning section 41 is provided with functions to be commonly used for the entire image forming apparatuses 30 and other functions for conducting overall controlling operations of the Universal Printer Driver software. The functions to be commonly used includes the function for converting the document data which has been created by executing the application programs 21b into a language that is interpretable by each of the image forming apparatuses 30, so as to create a print job, where the language is the PDL (Page Description Language) such as the PCL (Printer Control Language), the PS (Post Script), and the like.

The individual functioning sections (referred as child drivers) 42 are programs (instructions) respectively provided for various models, so as to respectively handle individual functions of the image forming apparatuses 30 (which are provided as group of files for respectively implementing unique functions of the image forming apparatuses 30). As such cases that, for instance, an individual functioning section “A” corresponds to an image forming apparatus 30 of model “A” and an individual functioning section “B” corresponds to another image forming apparatus 30 of model “B”, various kinds of independent modules respectively correspond to the image forming apparatuses 30 for every model thereof. In a case where plural image forming apparatuses 30 belong to the same model (for instance, model “A”), only a single individual functioning section “A” may be provided for the plural image forming apparatuses 30. However, in such a case that the plural image forming apparatuses 30 belong to the same model but the functions provided therein are different from each other (for instance, such a case that an image forming apparatus 30 having an optional function for implementing a finisher function, and another image forming apparatuses 30 having no such the optional function are mingled within the same system), the individual functioning sections may be separately provided for the plural image forming apparatuses 30 depending on the difference between the optional functions thereof, while the individual functioning sections are prepared for the same model use. Each of the individual functioning sections 42 keeps such information that represents what kind of function is provided in the image forming apparatuses 30 concerned, what kind of screen arrangement is to be employed for displaying the screen, and what kind of character string is to be displayed on the screen, regarding a corresponding model. Based on the information kept in the functioning section 42 of the image forming apparatus 30 currently selected, the functioning section 42 displays a print setting screen on the display section 24 of the client apparatus 20.

The apparatus managing section 43 is provided with the following functions. One of the functions is a function to transmit live confirming information (for example, a Ping packet) to the image forming apparatuses 30 with designating identification information of the image forming apparatuses 30 (for instance, an IP address representing a location on the network, or a MAC (Media Access Control) address inherent to the communication interface section 33) and to confirm whether or not each of the image forming apparatuses 30 is currently living (whether or not connected to the network), based on the result of receiving response information in response to the live confirming information. Another of the functions is a function to display an apparatus selecting screen on the display section 24 of the client apparatus 20, where the apparatus selecting screen allow a user to select a specific image forming apparatus 30 to be an output target from among plural image forming apparatuses 30 that have responded to the Ping packet. Still another of the functions is a function to acquire apparatus information from the image forming apparatus 30 selected in the above apparatus selecting screen. As aforementioned, in the case where the image forming apparatuses 30 are in conformity with the SNMP, since the apparatus information is kept as the object in the MIB having a tree structure, it is possible for the client apparatus 20 to acquire the apparatus information of the image forming apparatus 30 concerned, by employing the SNMP manager command for designating the OID (Object Identifier).

The apparatus information database 44 retains the identification information of the image forming apparatuses 30 and information in regard to the functions respectively corresponding to the image forming apparatuses 30, as an apparatus information list. FIG. 5 is a table illustrating an example of the apparatus information list, including the column of “Device Name”, to be filled with apparatus names of the image forming apparatuses 30; the column of “Size”, to be filled with sizes of paper sheets for each of which the corresponding image forming apparatus 30 is capable of outputting an image; the column of “Color”, to be filled with “Color” or “B & W” which indicates whether or not the corresponding image forming apparatus 30 is capable of outputting a color image; the column of “IP Address”, to be filled with IP addresses representing locations of the devices on the network; and the column of “MAC Address”, to be filled with numbers each of which represents a unique number inherent to the communication interface section 33 concerned.

The processing to be conducted by the Universal Printer Driver software, having the above-mentioned configuration, will be detailed in the following. Initially, referring to the flowchart shown in FIG. 6, the startup processing of the Universal Printer Driver will be detailed in the following.

The apparatus managing section 43 of the Universal Printer Driver software acquires the apparatus information list shown in FIG. 5 from the apparatus information database 44 (Step S101), and sequentially takes out the MAC Addresses (or the IP Addresses) filled in the apparatus information list (Step S102).

Successively, the apparatus managing section 43 employs each of the MAC Addresses (or the IP Addresses) above-acquired to conduct a live confirmation processing for each of the image forming apparatuses 30 (Step S103). The flowchart shown in FIG. 7 illustrates details of Step S103. At first in the live confirmation processing, the apparatus managing section 43 transmits a Ping packet to each of the image forming apparatuses 30 (Step S201), and waits responses to the Ping packet (Step S202). The Ping packet above-mentioned is provided as a program, which makes it possible to diagnosis the TCP/IP (Transmission Control Protocol/Internet Protocol) network, in such a manner that the apparatus managing section 43 casts an “echo request” packet of the ICMP (Internet Control Message Protocol) to an image forming apparatus designated as a target apparatus in advance, and then, determines whether or not the concerned image forming apparatus is living (connected to the network), depending on whether or not an “echo reply” packet is fed back from the concerned image forming apparatus. Since each of the image forming apparatuses 30 is configured to make a response the Ping packet through the communication interface section 33, it is unnecessary to make the concerned image forming apparatus 30 which is currently in the sleep state, return to the ready state for making the response, which reduces the electric power consumption consumed by the image forming apparatuses 30.

Successively, upon receiving the response to the Ping packet from one of the image forming apparatuses 30 (Step S202; YES), the apparatus managing section 43 determines that the concerned image forming apparatus 30 is currently living (Step S203), and finalizes the live confirmation processing. On the other hand, when receiving no response to the Ping packet from one of the image forming apparatuses 30 within a predetermined time interval (Step S202; NO and Step S204; YES), the apparatus managing section 43 returns to Step S201 to repeat the operation to transmit the Ping packet until the repetition number reaches to a retry number established in advance. When the repetition number exceeds the retry number (Step S205; YES), the apparatus managing section 43 determines that the concerned image forming apparatus 30 is not currently living (Step S206), and finalizes the live confirmation processing.

Still successively, returning to the flowchart shown in FIG. 6, the apparatus managing section 43 determines whether or not the live confirmation processing in regard to all of image forming apparatuses 30 has been completed (Step S104). Upon determining that the live confirmation processing has not been completed, the apparatus managing section 43 returns to Step S102 to implement the live confirmation processing. Then, upon determining that the live confirmation processing in regard to all of image forming apparatuses 30 has been completed, the apparatus managing section 43 creates display data to be used for notifying image forming apparatuses 30 that are currently living to a user, based on information in regard to responses to the Ping packet (Step S105), and operates the display section 24 to display the apparatus selecting screen based on the display data (Step S106).

FIG. 8 is a schematic diagram showing an example of the apparatus selecting screen to be displayed on the display section 24 of the client apparatus 20. Herein, since the apparatus managing section 43 has received no response to the Ping packet from the image forming apparatus 30 whose IP address is “192.168.0.102” among the four sets of image forming apparatuses 30, the other three sets of image forming apparatuses 30 whose IP addresses are “192.168.0.101”, “192.168.0.103” and “192.168.0.104”, respectively, are indicated in the apparatus selecting screen. In the screen, since the other three sets of image forming apparatuses 30 responds to the Ping packet without returning to the ready state from the sleep state, the statuses of them are kept at “Unknown (alive)”.

Next, referring to the flowchart shown in FIG. 9, the processes to be conducted by the Universal Printer Driver software in a case where a user performs operations onto the apparatus selecting screen, will be detailed in the following.

The apparatus managing section 43 monitors the user's operations performed onto the apparatus selecting screen (Step S301), and, at the time when detecting an operation to depress the “OK” button provided in the apparatus selecting screen (Step S302; YES), confirms whether or not one of the image forming apparatuses 30 is selected (Step S303). In this step, since none of the image forming apparatuses 30 is selected (Step S303; NO), the processing is finalized (END). In addition, when an operation to depress the “Cancel” button is detected in Step S302, the processing is also finalized as well (END).

On the other hand, when detecting a user's operation to select a specific image forming apparatus 30 in Step S301, the apparatus managing section 43 acquires address information of the selected image forming apparatus 30 from the apparatus information list (Step S305). Then, the apparatus managing section 43 transmits an acquisition request of the apparatus information to the selected image forming apparatus 30, to acquire the apparatus information thereof (Step S306). As aforementioned, it is possible to acquire the apparatus information from the MIB, by employing the SNMP manager command for designating the OID.

Successively, based on the apparatus information above-acquired, the apparatus managing section 43 updates the display data of the apparatus selecting screen (Step S307), and also updates the contents of the screen to be displayed on the display section 24 (Step S308). For instance, when an user selects Printer “A” from the apparatus selecting screen shown in FIG. 8, since the Printer “A” returns to the ready state in order to process the acquisition request of the apparatus information transmitted through the Universal Printer Driver software, the “Status” indication of the Printer “A” is changed from “Unknown (alive)” to “Ready” as shown in FIG. 10. Accordingly, it becomes possible for a user to issue a print instruction to the specific image forming apparatus 30 desired by the user without making the unnecessary image forming apparatuses 30 returns to the ready state.

After the specific image forming apparatus 30 has been selected by the user, the apparatus managing section 43 again monitors the user's operations performed onto the apparatus selecting screen (Step S301), and, at the time when detecting an operation to depress the “OK” button provided therein (Step S302; YES), confirms whether or not one of the image forming apparatuses 30 is selected (Step S303). In this step, since one of the image forming apparatuses 30 has been selected (Step S303; YES), corresponding one of the individual functioning sections 42 displays a print setting screen corresponding to the selected image forming apparatus 30. Successively, according to the print conditions established from the print setting screen concerned, the common functioning section 41 transmits a print job to the selected image forming apparatus 30 (Step S304), and then, the concerned image forming apparatus 30 implements the print processing.

Further, when a user selects one of functions from the apparatus selecting screen in Step S301, the apparatus managing section 43 determines a target image forming apparatus 30 provided with the selected function, with referring to the information written in the apparatus information list (information of “Size” and “Color” in the apparatus information list shown in FIG. 5) (Step S309), and acquires the address information of the target image forming apparatus 30 above-determined (Step S310). Successively, the apparatus managing section 43 transmits an acquisition request of the apparatus information to the determined image forming apparatus 30, to acquire the apparatus information thereof (Step S311), and repeats the processing from Step S309 to Step S311, until the apparatus managing section 43 extracts all of the target image information apparatuses 30 and acquires apparatus information in regard to all of the target image forming apparatuses 30 (Step S312).

Successively, based on the apparatus information above-acquired, the apparatus managing section 43 updates the display data of the apparatus selecting screen (Step S313), and also updates the contents of the screen to be displayed on the display section 24 (Step S308). For instance, when an user selects “A3” as the sheet size and selects “Color” or “B & W (Monochrome)” as the color, on the apparatus selecting screen shown in FIG. 8, the apparatus managing section 43 transmits the acquisition request of the apparatus information to each of the Printer “C” and Printer “D”, whose “Size” column is filled with “A3”. Both the Printer “C” and the Printer “D” return to the ready state in order to process the acquisition request of the apparatus information transmitted from the Universal Printer Driver software on receiving the acquisition request. Therefore, the “Status” indication of the Printer “C” is changed from “Unknown (alive)” to “Ready”, while, due to the fact that the Printer “D” is currently out of paper sheets, the “Status” indication of the Printer “D” is changed from “Unknown (alive)” to “Paper empty”, as shown in FIG. 11. Accordingly, it becomes possible for a user to recognize a current state of an image forming apparatus 30 provided with a function desired by the user without making the unnecessary image forming apparatuses 30 returns to the ready state.

After the target image forming apparatuses 30 provided with the function designated have been selected, the apparatus managing section 43 again monitors the user's operations performed onto the apparatus selecting screen (Step S301), and, at the time when detecting an operation to depress the “OK” button provided therein (Step S302; YES), confirms whether or not one of the image forming apparatuses 30 is selected (Step S303). In a case where there is only a single set of image forming apparatus 30 provided with the designated function, or in a case where a specific image forming apparatus 30 is selected on the apparatus selecting screen shown in FIG. 11 (Step S303; YES), one of the individual functioning sections 42 displays a print setting screen corresponding to the selected image forming apparatus 30. Successively, according to the print conditions established from the print setting screen concerned, the common functioning section 41 transmits a print job to the selected image forming apparatus 30 (Step S304), and then, the concerned image forming apparatus 30 implements the print processing.

According to the flowchart shown in the above, it is possible for a user to depress the “OK” button, even before the user selects one of the image forming apparatuses 30. Alternatively, a user may be allowed to depress the “OK button”, after the apparatus information has been acquired from an image forming apparatus 30, and the status of the image forming apparatus 30 concerned has turned to “Ready”.

Further, according to the flowchart shown in the above, an example of selecting both the “Size” and “Color” is exemplified as the selecting function. However, only one of them may be selected, or in a case where another function is filled into the apparatus information list, the other function may he selected.

Still further, according to the flowchart shown in the above, the acquisition request of the apparatus information is individually transmitted to the apparatus selected after implementing the live confirming operation thereof without broadcasting the acquisition request of the apparatus information. Alternatively, a user may be allowed to select any one of: the first operation mode in which the acquisition request of the apparatus information is individually transmitted to the selected apparatus after the live confirming processing is completed; and the second operation mode in which, according to the conventional method, a broadcast transmission of the acquisition request of the apparatus information is performed to all of the apparatuses in the system.

Furthermore, according to the flowchart shown in the above, after one of the image forming apparatuses 30 has been selected, the apparatus information of the selected image forming apparatus 30 is acquired therefrom, and then, the print setting screen corresponding to the selected image forming apparatus 30 is displayed. Alternatively, in the state shown in FIG. 8 (in the state that currently-living image forming apparatuses 30 are displayed), it is also possible to display the print setting screen corresponding to the selected image forming apparatus 30 by employing the information filled into the apparatus information list. In this manner, by displaying the print setting screen in such the state that the apparatus information has not been acquired, it may be possible to make the image forming apparatus 30 returns to the ready state after the print setting operation is completed. As a result, it becomes possible to further reduce the electric power consumption of the image forming apparatuses 30.

In the foregoing, the present embodiment has been described on the premise that the Universal Printer Driver software keeps the apparatus information list. However, since it can be consider such a case that the Universal Printer Driver software does not keep the apparatus information list, or the apparatus information list currently kept by the Universal Printer Driver software is not latest information, it is preferable that the Universal Printer Driver software causes a process to confirm contents of the apparatus information list at the time when the printer driver is started. Referring to the flowchart shown in FIG. 12, the confirmation processing of the apparatus information list will be detailed in the following.

At first, the apparatus managing section 43 confirms whether or not the apparatus information list is already created (in other words, whether or not the apparatus information list is stored in the apparatus information database 44) (Step S401). When confirming that the apparatus information list is already created, the apparatus managing section 43 further confirms whether or not the apparatus information list is updated within a predetermined time interval (Step S402).

When confirming that the apparatus information list has already been created (Step S401; YES) and the apparatus information list has been updated within the predetermined time interval (Step S402; YES), it can be regarded that the apparatus information list precisely describes the present state of the apparatuses concerned. Therefore, the apparatus managing section 43 implements the startup processing indicated in the flowchart shown in FIG. 6 (Step S404). On the other hand, when confirming that the apparatus information list is not created (Step S401; NO), or the apparatus information list has not already been created (Step S401; YES) but has not been updated within the predetermined time interval (Step S402; NO), there is a possibility that the apparatus information list does not precisely describe the present state of the apparatus concerned. Therefore, the apparatus managing section 43 conducts, for instance, the apparatus searching operation through the broadcasting transmission and the individual-apparatus information acquiring operation to create the apparatus information list (Step S403), and after that, implements the startup processing indicated in the flowchart shown in FIG. 6 (Step S404).

Performing the above-mentioned processes makes information about the image forming apparatus 30, the power source of which is temporarily turned OFF, the other image forming apparatus 30, which is newly installed, still the other image forming apparatus 30, which is already removed, and so on, to be reflected onto the apparatus information list, which allows a user to transmit a print instruction to the appropriate image forming apparatus 30.

The scope of the present invention is not limited to the aforementioned embodiment. Disclosed configurations and controlling operations of the aforementioned embodiment of the present invention can be varied by a skilled person without departing from the spirit and scope of the invention.

For instance, in the foregoing, such the case that the Ping packet is transmitted as the live confirming information, has been described as the embodiment of the present invention. Alternatively, any kind of method may be applicable for this purpose, as far as the image forming apparatus 30 can respond without making the image forming apparatus 30 returns to (making the image forming apparatus returns to the “ready state” from the “sleep state”).

1. A printing system comprising:
a plurality of image forming apparatuses each configured to perform print processing; and
a print instruction apparatus connected to the plurality of image forming apparatuses through a communication network and being capable of transmitting a print instruction to each of the plurality of image forming apparatuses,
wherein the print instruction apparatus comprises:
a control section configured to control operations to transmit the print instruction to each of the plurality of image forming apparatuses, the control section including
a database configured to hold an apparatus information list, the apparatus information list including at least identification information of each of the plurality of image forming apparatuses, and
an apparatus managing section configured to
transmit live confirming information to confirm a live status to each of the plurality of image forming apparatuses with referring to the apparatus information list, the live confirming information being information to which each of the plurality of image forming apparatuses under a power-saving state can respond, the power-saving state being a state in which the each of the plurality of image forming apparatuses consumes less power than in a normal-power state,
recognize image forming apparatuses connected to the communication network, as recognized image forming apparatuses, out of the plurality of image forming apparatuses, based on whether or not the apparatus managing section receives information responding to the live confirming information,
transmit an acquisition request to acquire apparatus information to an image forming apparatus selected on a screen, as a selected image forming apparatus, the screen showing a list of the recognized image forming apparatuses, the acquisition request being a request to which the each of the plurality of image forming apparatuses under the normal-power state can respond, and
acquire the apparatus information from the selected image fowling apparatus so that the print instruction apparatus can transmit a print instruction to the selected image forming apparatus; and
a display section configured to display the screen showing the list of the recognized image forming apparatuses so as to allow a user to select at least one of the recognized image forming apparatuses, and
wherein each of the plurality of image forming apparatuses is configured to
transmit, in response to a reception of the live confirming information, the information responding to the live confirming information to the print instruction apparatus without returning from the power-saving state to the normal-power state, and
generate the apparatus information with returning to the normal-power state, in response to a reception of the acquisition request of the apparatus information transmitted to the selected image forming apparatus.

2. The printing system of claim 1,
wherein the apparatus information list includes information about functions of the plurality of image forming apparatuses, and
the apparatus managing section of the print instruction apparatus is configured to, in response to a selection of one of the functions performed on the screen, extract one or more image fanning apparatuses having the one of the functions as the selected image forming apparatus, with referring to the apparatus information list.

3. The printing system of claim 1,
wherein the apparatus managing section of the print instruction apparatus is configured to, in response to a reception of the apparatus information from the selected image forming apparatus, display an apparatus status of the selected image forming apparatus in the screen.

4. The printing system of claim 1,
wherein the apparatus managing section of the print instruction apparatus is configured to, after the transmitting the live confirming information to each of the plurality of image forming apparatuses, allow a user to select one of a first operation mode and a second operation mode, the first operation mode causing the apparatus managing section to transmit the acquisition request of the apparatus information to the selected image forming apparatus, the second operation mode causing the apparatus managing section to perform a broadcast transmission of the acquisition request of the apparatus information to the plurality of image forming apparatuses without transmitting the live confirming information to each of the plurality of image forming apparatuses.

5. The printing system of claim 1,
wherein the live confirming information is a Ping packet.

6. A print instruction apparatus connected to a plurality of image forming apparatuses through a communication network and being capable of transmitting a print instruction to each of the plurality of image forming apparatuses, the print instruction apparatus comprising:
a control section configured to control operations to transmit the print instruction to each of the plurality of image forming apparatuses, the control section including
a database configured to hold an apparatus information list, the apparatus information list including at least identification information of each of the plurality of image forming apparatuses, and
an apparatus managing section configured to
transmit live confirming information to confirm a live status to each of the plurality of image forming apparatuses with referring to the apparatus information list, the live confirming information being information to which each of the plurality of image forming apparatuses under a power-saving state can respond, the power-saving state being a state in which the each of the plurality of image forming apparatuses consumes less power than in a normal-power state,
recognize image forming apparatuses connected to the communication network, as recognized image forming apparatuses, out of the plurality of image forming apparatuses, based on whether or not the apparatus managing section receives information responding to the live confirming information,
transmit an acquisition request to acquire apparatus information to an image forming apparatus selected on a screen, as a selected image forming apparatus, the screen showing a list of the recognized image forming apparatuses, the acquisition request being a request to which the each of the plurality of image forming apparatuses under the normal-power state can respond, and
acquire the apparatus information from the selected image forming apparatus so that the print instruction apparatus can transmit a print instruction to the selected image forming apparatus; and
a display section configured to display the screen showing the list of the recognized image forming apparatuses so as to allow a user to select at least one of the recognized image forming apparatuses.

7. The print instruction apparatus of claim 6,
wherein the apparatus information list includes information about functions of the plurality of image forming apparatuses, and
the apparatus managing section is configured to, in response to a selection of one of the functions performed on the screen, extract one or more image forming apparatuses having the one of the functions as the selected image forming apparatus, with referring to the apparatus information list.

8. The print instruction apparatus of claim 6,
wherein the apparatus managing section is configured to, in response to a reception of the apparatus information from the selected image forming apparatus, display an apparatus status of the selected image forming apparatus in the screen.

9. The print instruction apparatus of claim 6,
wherein the apparatus managing section is configured to, after the transmitting the live confirming information to each of the plurality of image forming apparatuses, allow a user to select one of a first operation mode and a second operation mode, the first operation mode causing the apparatus managing section to transmit the acquisition request of the apparatus information to the selected image forming apparatus, the second operation mode causing the apparatus managing section to perform a broadcast transmission of the acquisition request of the apparatus information to the plurality of image forming apparatuses without transmitting the live confirming information to each of the plurality of image forming apparatuses.

10. The print instruction apparatus of claim 6,
wherein the live confirming information is a Ping packet.

11. A non-transitory computer-readable storage medium storing printer driver software, serving as a computer executable program to be executed in a print instruction apparatus connected to a plurality of image forming apparatuses through a communication network, the print instruction apparatus being capable of transmitting a print instruction to each of the plurality of image forming apparatuses, the print instruction apparatus including a database holding an apparatus information list, the apparatus information list including at least identification information of each of the plurality of image forming apparatuses, the program being executable by a computer to cause the computer to perform a process comprising:
transmitting live confirming information to confirm a live status to each of the plurality of image forming apparatuses with referring to the apparatus information list, the live confirming information being information to which each of the plurality of image forming apparatuses under a power-saving state can respond, the power-saving state being a state in which the each of the plurality of image forming apparatuses consumes less power than in a normal-power state,
recognizing image forming apparatuses connected to the communication network, as recognized image forming apparatuses, out of the plurality of image forming apparatuses, based on a receipt of information responding to the live confirming information,
transmitting an acquisition request to acquire apparatus information to an image forming apparatus selected on a screen, as a selected image forming apparatus, the screen showing a list of the recognized image forming apparatuses, the acquisition request being a request to which the each of the plurality of image forming apparatuses under the normal-power state can respond,
acquiring the apparatus information from the selected image forming apparatus so that the print instruction apparatus can transmit a print instruction to the selected image forming apparatus; and
transmitting a print instruction to the selected image forming apparatus.

12. The non-transitory computer-readable storage medium of claim 11,
wherein the apparatus information list includes information about functions of the plurality of image forming apparatuses, and
the transmitting the acquisition request includes, extracting one or more image forming apparatuses having the one of the functions as the selected image forming apparatus, with referring to the apparatus information list, in response to a selection of one of the functions performed on the screen.

13. The non-transitory computer-readable storage medium of claim 11,
wherein the acquiring the apparatus information from the selected image forming apparatus includes, in response to a reception of the apparatus information from the selected image forming apparatus, displaying an apparatus status of the selected image forming apparatus in the screen.

14. The non-transitory computer-readable storage medium of claim 11,
wherein the processes further includes, after the transmitting the live confirming information to each of the plurality of image forming apparatuses, allowing a user to select one of a first operation mode and a second operation mode, the first operation mode causing the computer to transmit the acquisition request of the apparatus information to the selected image forming apparatus, the second operation mode causing the computer to perform a broadcast transmission of the acquisition request of the apparatus information to the plurality of image forming apparatuses without transmitting the live confirming information to each of the plurality of image forming apparatuses.

15. The non-transitory computer-readable storage medium of claim 11,
wherein the live confirming information is a Ping packet.

16. The non-transitory computer-readable storage medium of claim 11,
wherein the printer driver software is universal printer driver software, serving as a computer executable program, the program being executable by the computer to cause the computer to transmit a print instruction to each of plural kinds of the image forming apparatuses.
